(19) United States
(12) Patent Application Publication
(10) Pub. No.: US 2012/0244269 A1
(43) Pub. Date: Sep. 27, 2012

(54) FOOD MADE OF BEAN PEEL AS RAW MATERIAL AND METHOD FOR PRODUCING FOOD MATERIAL THEREOF

(76) Inventor: Kiyosumi HATTORI, Tokyo (JP)

(21) Appl. No.: 13/470,777

(22) Filed: May 14, 2012

Related U.S. Application Data
(62) Division of application No. 12/656,146, filed on Jan. 19, 2010.

(30) Foreign Application Priority Data
Jan. 19, 2009 (JP) 2009-009345

(51) Int. Cl. B02C 19/00; A23P 1/10

(52) U.S. Cl. 426/482

(57) ABSTRACT

A method for producing a food material made of a bean peel as a raw material includes dehydrating a peel separated from boiled adzuki beans into a predetermined water content, primary milling the peel obtained by the dehydration step into a desired particle size water addition for adjusting, by water addition, the water content of the peel powder obtained by the primary milling step to a predetermined level, and a secondary milling of the peel powder obtained by the water addition adjustment step into fine particles such that the palisade tissues of the peel powder are separated in a fine, almost rod-like (elongated) form.

### BACKGROUND OF THE INVENTION

1. Field of the Invention

The present invention relates to a food made of a bean peel as a raw material, which is rich in the original taste of the bean (e.g., adzuki bean or kidney bean) and in active ingredients such as dietary fiber and minerals, and a method for producing a food material thereof.

2. Description of the Related Art

For example, adzuki beans have been known widely since ancient times as nutritious food materials (edibles) rich in energy sources such as carbohydrates, lipids, and proteins.

Examples of active ingredients contained in the adzuki beans include carbohydrates, proteins, dietary fiber, iron, B-complex vitamins, polyphenols (e.g., anthocyanin), and minerals (e.g., calcium, magnesium, potassium, and iron).

A bean paste is produced through a series of bean paste production steps, for example, as shown in FIG. 1. Briefly, raw material adzuki beans a such as Hokkai Adzuki (adzuki beans cultivated in Hokkaido, Japan) are first placed in weighed quantity, together with water, in a cooker and boiled at 98° C. for 10 to 30 minutes for removal of astringency (S1). As a result, astringent components are extracted into the broth from the adzuki beans and discharged as a waste liquid from the cooker.

Then, the astringency-removed adzuki beans are boiled again at 98° C. for 30 to 60 minutes in main boiling (S2). Next, hot water is discharged from the cooker, and the boiled adzuki beans remaining in the cooker are then mashed (S3), and the mashed, boiled adzuki beans are sifted (S4). This sifting separates peels from the boiled adzuki beans.

Subsequently, the boiled adzuki beans separated from the peels are continuously dipped in water (S5), cooled by dipping in a large amount of water (S6), and then dehydrated (S7) to produce a bean paste B.

The bean paste thus obtained is weighed and packed (S8) and refrigeration-stored (S9).

On the other hand, people often take an excessive amount of calories, for example, with changes in their living environments, particularly, their diets due to westernization, in recent years. As a result, an increasing number of people suffer from obesity. In such obesity, hyperlipemia exhibiting large contents of neutral fats and cholesterol in blood is often seen, leading to the problem of increase in the number of lifestyle-related diseases such as arteriosclerosis, hypertension, and diabetes mellitus. As a measure thereagainst, health foods have received attention, from which active ingredients (functional ingredients) such as vegetable fiber and minerals can be taken easily in spite of their low calories.

Thus, conventional techniques are known: health foods such as a pudding (canned pudding) or concentrated drink made of, as a raw material, an adzuki bean broth discharged from a pot by an astringency removal step in bean paste production steps with said adzuki beans as a raw material; and methods for producing a food material thereof (see e.g., Japanese Patent Laid-Open No. 2003-250476 (see paragraph numbers 0011, 0017, 0026, 0031, and 0033, and FIGS. 1 and 2)).

Meanwhile, a broth separated and extracted from adzuki beans after the boiling step for removal of astringency (S1) in the process of bean paste (strained bean jam) production has previously been utilized, without being disposed of, as a food material for health foods as described in Japanese Patent Laid-Open No. 2003-250476. Thus, the broth, which contains large amounts of active ingredients such as polyphenol components (e.g., saponin and anthocyanin) and potassium, has previously been utilized as a food material for a pudding, concentrated drink, or the like.

However, the peel portion of adzuki beans rich in active ingredients such as dietary fiber and minerals has been disposed of or used as feed for livestock under the presence circumstances, for example, because the peel is difficult to process because of being fibrous.

Thus, the present invention has been achieved in consideration of such previous circumstances, and an object of the present invention is to provide a food which is rich in active ingredients contained in a bean (e.g., adzuki bean) peel and has the original favorable taste of the bean and a low calorie, and a method for producing a food material thereof.

### SUMMARY OF THE INVENTION

To attain said object, the present inventors have conducted diligent studies for long years and consequently completed the present invention by focusing on a bean peel which is rich in active ingredients such as dietary fiber and minerals and has a low calorie (amount of heat). Specifically, the present inventors have found a production method using a wet milling process capable of milling a bean peel into a particle size that allows the peel to have smooth texture in eating. Based on the findings, the present invention has been completed.

Specifically, a food made of a bean peel as a raw material according to the present invention is made of, as a raw material, a powder of a bean peel milled into fine particles with a desired particle size by a wet milling process. In this context, said particle size is 20 to 80 μm, and particle size distribution thereof is preferably 50% or more in terms of a relative particle volume in cumulative Q3 distribution.

Said bean peel used as a raw material is rich in active ingredients such as dietary fiber and minerals.

Moreover, a method for producing a food material made of a bean peel as a raw material according to the present invention comprises: a primary milling step of milling a peel separated from a bean, into a desired particle size; and a secondary milling step of milling the peel powder obtained by this primary milling step, into fine particles with a finer particle size by a wet milling process.

The method for producing a food material made of a bean peel as a raw material further comprises, after said primary milling step, a water addition adjustment step of adjusting the water content of the peel powder obtained by this primary milling step, to 95 to 90%, wherein said wet milling process is an ultra-high--pressure milling process performed under a pressure of 80 to 200 Mps and wherein said peel powder obtained by said wet milling process has a processed particle size of 20 to 80 μm and particle size distribution of 50% or more in terms of a relative particle volume in cumulative Q3 distribution.

The present invention can provide a health food which is rich in active ingredients (functional ingredients) such as dietary fiber and minerals contained in a bean (e.g., adzuki bean) peel, without waste of the active ingredients, and has the original favorable taste of the bean and an exceedingly low calorie.

The present invention can also provide a method for producing a food material, which dose not destroy active ingredients (functional ingredients) such as dietary fiber and minerals contained in abundance in a bean (e.g., adzuki bean) peel and is capable of milling a peel powder into fine particles that allow the peel to have smooth texture in eating such that the palisade tissues of the peel powder are separated in a fine, almost rod-like form.

### BRIEF DESCRIPTION OF THE DRAWINGS

FIG. 1 is a block diagram showing, in order, general bean paste production steps for producing an adzuki bean peel used as a raw material for a food material according to the present invention;

FIG. 2 is a block diagram showing, in order, production steps for milling the peel obtained by the bean paste production steps, into fine particles by a wet milling process;

FIG. 3 is a microscope photograph of an adzuki bean peel powder obtained in the present Example;

FIG. 4 is a microscope photograph of an adzuki bean peel powder obtained by a conventional dry milling process;

FIG. 5 is a graph showing cumulative Q3 distribution based on the relationship between the particle size of the adzuki bean peel powder obtained in the present Example and its relative particle volume;

FIG. 6 is a graph showing frequency q3 distribution based on the relationship between the particle size of the adzuki bean peel powder obtained in the present Example and its relative particle volume; and

FIG. 7 is a block diagram showing, in order, production steps of another embodiment for milling a peel separated from raw adzuki beans, into fine particles by a wet milling process.

### DETAILED DESCRIPTION

Hereinafter, the embodiments of the present invention will be described.

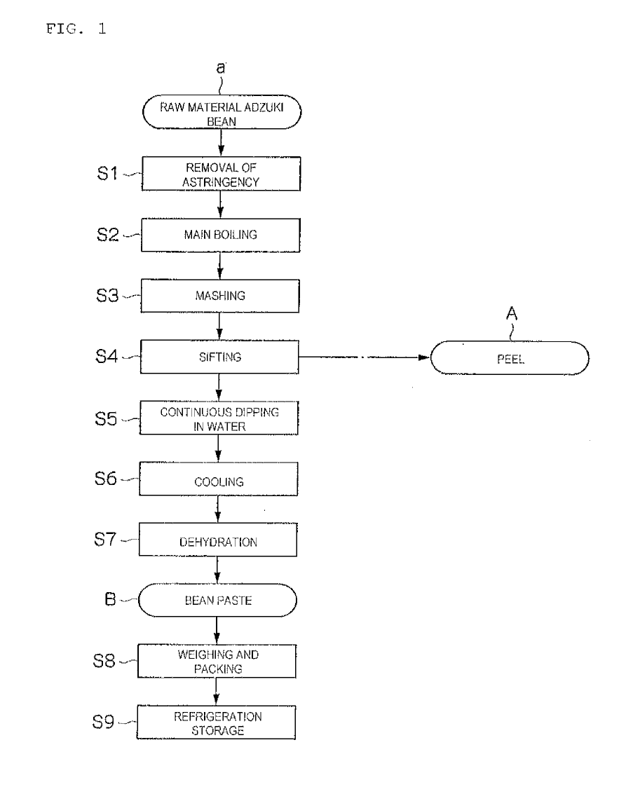

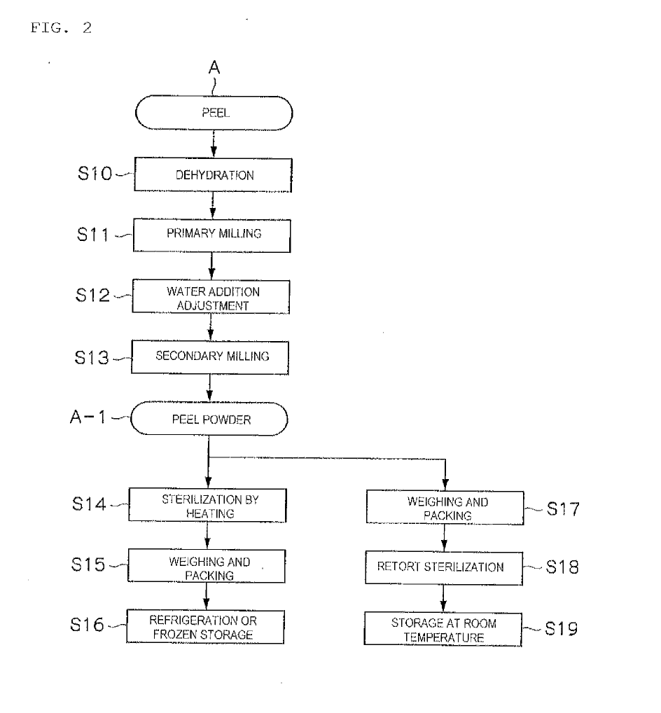

FIG. 1 is a block diagram showing, in order, general bean paste production steps for producing an adzuki bean peel used as a raw material for a food material according to the present invention, and FIG. 2 is a block diagram showing, in order, production steps for milling the peel obtained by the bean paste production steps, into fine particles by a wet milling process.

In the present embodiment, the bean paste production steps for producing a peel (seed coat) A of raw material adzuki beans a are as described in said section Description of the Related Art. The same reference characters will be used to designate the same components as those therein, so that the description will be omitted.

As shown in FIG. 1, the peel A of the adzuki beans a used as a raw material for a food material is separated from the boiled adzuki beans by a sifting step (S4) following a mashing step (S3) for the boiled adzuki beans in the bean paste production steps.

The peel A thus obtained by separation from the boiled adzuki beans in the bean paste production steps is first dehydrated (S10) into a water content of 70 to 80%, as shown in FIG. 2. This dehydration process is used to confirm (determine) the solid content of the peel A, while promoting the in-pipe transfer (flow) of the peel through a transfer pipe for the next step.

Next, the dehydrated peel A is milled into a desired particle size (μm) in a primary milling process (preliminary milling) (S11). This primary milling process mills the peel A into a desired particle size that allows the peel A to be milled into fine particles in an ultra-high-pressure processor by a secondary milling process described later. For example, the peel A is milled into a particle size of 2.3 to 4.2Φ.

Subsequently, a water addition process (S12) is performed for adjusting the water content of the peel powder A-1 obtained by the primary milling process, to a predetermined level. This water addition process adjusts the water content of the peel powder. A-1 to 95 to 90%.

The peel powder A-1 having the water content adjusted by the water addition process is in-pipe-transferred for a secondary milling step of milling the peel powder into fine particles with a finer particle size by a wet milling process (S13). The wet milling process is an ultra-high-pressure milling process performed under a pressure of 80 to 200 Mps, preferably 100 to 150 Mps. This ultra-high-pressure milling process is performed using an ultra-high-pressure milling machine (model: AH20-2224) manufactured by ATAGO ENGINEERING K.K.

As a result, the adzuki bean peel powder A-1 is milled into fine particles with a particle size of 20 to 80 μm and used as a raw material for a food material. The particle size of the peel powder A-1 is preferably 30 to 60 μm.

The thus-obtained peel powder A-1 with a particle size of 30 to 60 μm is sterilized by heating (S14), then weighed and packed (S15), and refrigeration- or frozen-stored (S16), as shown in FIG. 2. Alternatively, the peel powder A-1 is weighed and packed (S17), then retort-sterilized (S18), and stored at room temperature (S19).

### [Particle Size and Particle Size Distribution]

Next, the particle size is compared between the adzuki bean peel powder of the present Example (hereinafter, referred to as an “Example product”) obtained by said ultra-high-pressure milling process (wet milling process) and an adzuki bean peel powder obtained by a conventional dry milling process (hereinafter, referred to as a “Comparative Example product”).

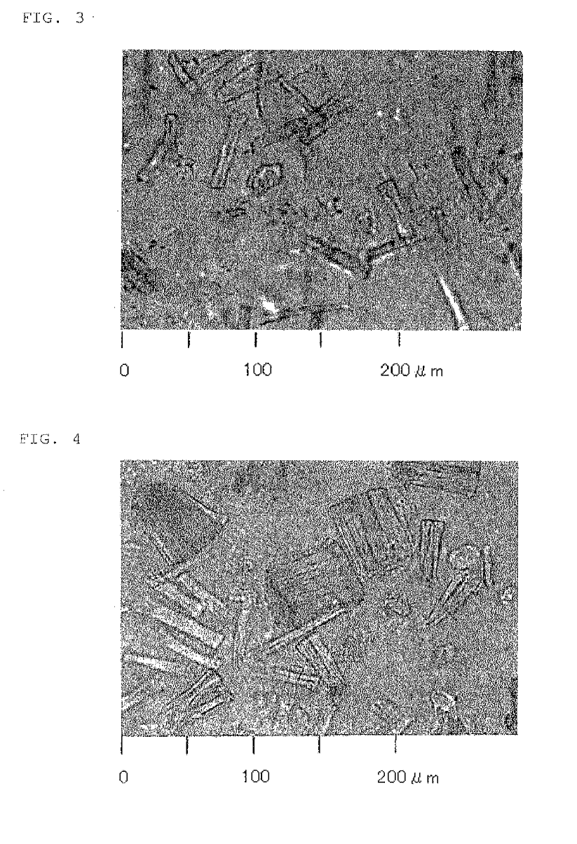

FIG. 3 is a microscope photograph of a peel powder obtained by an ultra-high-pressure milling process in the present Example, and FIG. 4 is a microscope photograph of a peel powder obtained by a conventional dry milling process.

The microscope photographs shown in FIGS. 3 and 4 demonstrate that the Example product has palisade tissues separated in a finer, almost rod-like form (rod-like particles) than those in the Comparative Example product, although the Example product and the Comparative Example product do not differ in particle size (μm).

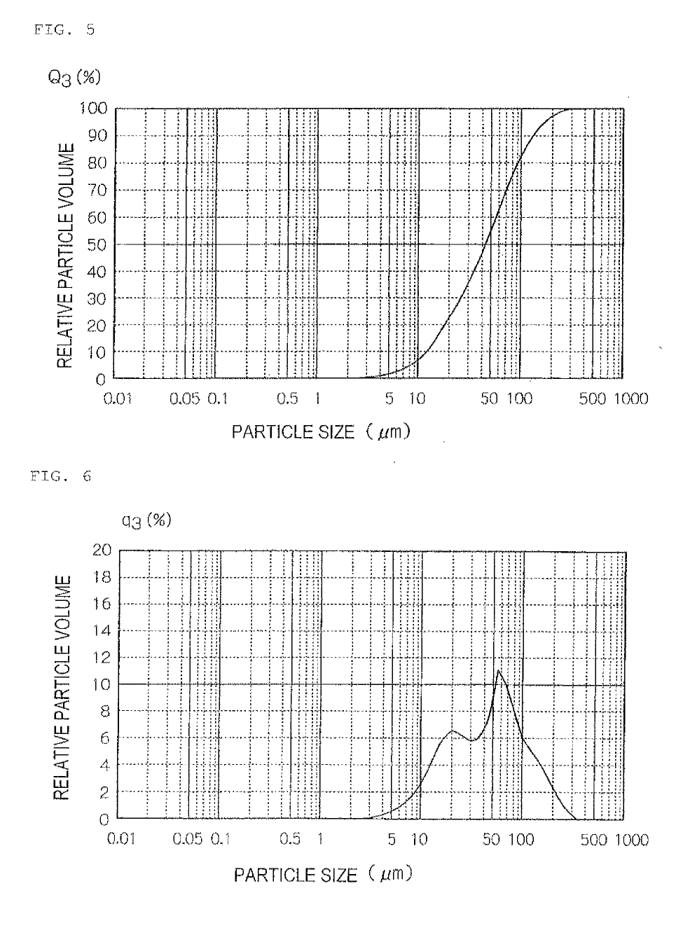

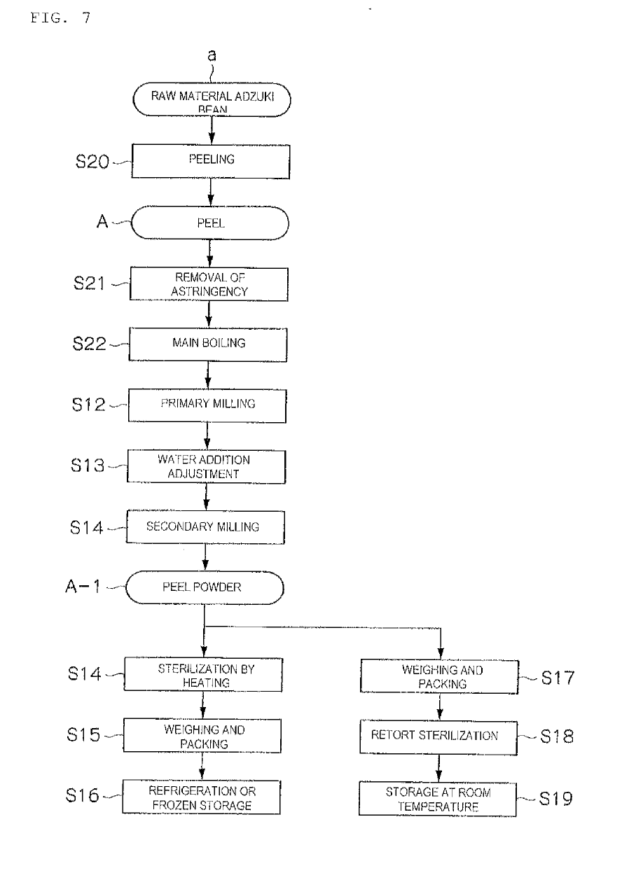

In the present Example, the particle size distribution of the adzuki bean peel powder obtained by said ultra-high-pressure milling process is confirmed by measurement under measurement conditions shown below, and the measurement results are shown in FIGS. 5 (cumulative Q3 distribution) and 6 (frequency q3 distribution). In this context, the cumulative Q3 distribution refers to cumulative distribution based on volume, and the frequency q3 distribution refers to frequency distribution based on volume.

Measurement Conditions
a. Measurement apparatus: laser diffraction particle size distribution analyzer (model SALD-2000j manufactured by Shimadzu Corp.)
b. Refractive index: 1.70-0.20i (standard refractive index was used).
c. Dispersion medium: water
d. Dispersion: ultrasonication for 5 minutes

As can be seen from the cumulative Q3 distribution shown in FIG. 5, the peel powder with a particle size of 20 to 80 μm is found to have a relative particle volume of 50% or more.

Examples of foods prepared from, as a raw material, the thus-obtained peel powder A-1 of the adzuki beans a that has palisade tissues separated in a fine, almost rod-like form and has a particle size of 30 to 60 μm can include zero- or low-calorie soft (adzuki-)bean jelly, jellies, red bean soups, and puddings. Other foods made thereof can include dressings, mixing raw materials for creams or ice creams, and swallowable foods. Further examples thereof include fiber- or mineral-fortified foods.

### EXAMPLE 1

Next, Preparation Example will be described, in which a commodity product was prepared using a peel powder A-1 of adzuki beans a as a food material obtained by said production method.

### PREPARATION EXAMPLE 1

### Soft Adzuki-Bean Jelly

[Formulation ratio (%)]

a. Adzuki bean peel powder: 15.000

b. Sugar alcohol: 6.000

c. Gelling agent: 0.420

d. Polysaccharide thickener: 0.120

e. High-sweetness sweetener: 0.044

f. Flavor: 0.230

g. Water: 78.186
Total: 100.000

According to such a formulation ratio, twenty 90-g containers (71 mm in diameter) of soft adzuki-bean jelly could be obtained.

As can be seen from a nutrient analysis table shown in Table 1, the thus-obtained soft adzuki-bean jelly contained in containers was rich in active ingredients such as dietary fiber and minerals contained in the peel powder A-1 of the adzuki beans a and had a reduced calorie (amount of heat) of carbohydrate, lipid, and protein. Specifically, low-calorie health foods rich in active ingredients such as dietary fiber and minerals could be obtained.

TABLE 1

| | Adzuki bean peel | |
|---|---|---|
| | (per 100 g) | |
| Amount of heat | 26 | kcal |
| Water | 88.8 | g |
| Protein | 1.1 | g |
| Lipid | smaller than 0.1 g | |
| Sugar | 0.3 | g |
| Vegetable fiber | 9.5 | g |
| Carbohydrate | 9.8 | g |
| Ash | 0.2 | g |
| Iron | 1.71 | mg |
| Sodium | 4.80 | mg |
| Potassium | 45.60 | mg |
| Calcium | 28.10 | mg |
| Magnesium | 16.30 | mg |
| Zinc | 0.71 | mg |

### [Sensory Evaluation]

In the present invention, males and females in their 20s to 60s tasted the thus-obtained soft adzuki-bean jelly (Example) and soft adzuki-bean jelly prepared at the formulation ratio described in detail in said Preparation Example 1 from an adzuki bean peel powder obtained by a conventional dry milling process (Comparative Example) and evaluated them according to the following two stages in a sensory test for confirming smooth texture. The results are shown in Table 2.

a. Smooth: O

b. Rough: X

TABLE 2

| | | | Comparative |
|---|---|---|---|
| Sex | Age | Example | Example |
| Male | 61 | ◯ | X |
| Male | 58 | ◯ | X |
| Male | 55 | ◯ | X |
| Male | 47 | ◯ | X |
| Male | 38 | ◯ | X |
| Male | 33 | ◯ | X |
| Female | 62 | ◯ | X |
| Female | 58 | ◯ | X |
| Female | 39 | ◯ | X |
| Female | 36 | ◯ | X |
| Female | 25 | ◯ | X |
| Female | 23 | ◯ | X |
| Female | 21 | ◯ | X |

As can be seen from Table 2, the soft adzuki-bean jelly of Example was evaluated as being smooth by all the generations of twenty- to sixtysomethings. By contrast, the soft adzuki-bean jelly of Comparative Example was evaluated as being rough by all the generations of twenty- to sixtysomethings.

As a result, the soft adzuki-bean jelly prepared from, as a raw material, the adzuki bean peel powder obtained by the production method of the present invention was demonstrated to have favorable smooth texture.

### Another Embodiment

Next, another embodiment of a production method will be described, in which a peel separated from raw adzuki beans is milled into fine particles by a wet milling process.

FIG. 7 is a block diagram showing, in order, production steps of another embodiment for milling a peel separated from raw adzuki beans, into fine particles by a wet milling process.

As shown in FIG. 7, the order of steps subsequent to the primary milling step (S11) (step of milling the peel A separated from the adzuki beans a, into a particle size of 2.3 to 4.2φ) described in detail in the production steps of said embodiment is basically the same as that described in detail in said embodiment. Therefore, the same reference characters will be used to designate the same steps as those therein, so that the description will be omitted.

Specifically, in the production method according to this embodiment, raw adzuki beans a as a raw material are mechanically peeled in peeling (S20), as shown in FIG. 7. Next, the peel A separated from the raw material adzuki beans a is first placed in weighed quantity, together with water, in a cooker and boiled at 98° C. for 10 to 30 minutes for removal of astringency (S21), as described in detail in said bean paste production steps. Then, the astringency-removed peel is boiled again at 98° C. for 30 to 60 minutes for main boiling (S22).

Subsequently, a peel powder A-1 with a particle size of 30 to 60 μm is obtained through the primary milling (S11), water addition adjustment (S12), and secondary milling (S13) steps, as in the production steps of said embodiment, and used as a raw material for a food material.

The production method according to this embodiment is effective for using soybeans as a raw material and milling a soybean peel into fine particles with a particle size of 30 to 60 μm by the production steps (S20 to S22 and S11 to S13) in said order.

### EXAMPLE 2

Next, Preparation Example will be described, in which a commodity product was prepared using a kidney bean peel powder obtained by using kidney beans as raw material beans and milling a peel of the kidney beans into fine particles with a particle size of 30 to 60 μm by the production steps described in detail in said embodiment.

### Preparation Example 2

### Green Tea Powder-Containing Soft Bean Jelly

[Formulation ratio (%)]

a. Kidney bean peel powder: 20.000

b. Sugar alcohol: 6.000

c. Gelling agent: 0.420

d. Polysaccharide thickener: 0.120

e. High-sweetness sweetener: 0.048

f. Flavor: 0.180

g. Green tea powder: 0.350

h. Pigment: 0.050

i. Water: 78.832
Total: 100.000

According to such a formulation ratio, twenty 90-g containers (71 mm in diameter) of green tea powder-containing soft bean jelly could be obtained.

As can be seen from a nutrient analysis table shown in Table 3, the thus-obtained green tea powder-containing soft bean jelly contained in containers was rich in active ingredients such as dietary fiber and minerals contained in the kidney bean peel powder and had a reduced calorie (amount of heat) of carbohydrate, lipid, and protein. Specifically, low-calorie health foods rich in active ingredients such as dietary fiber and minerals could be obtained.

TABLE 3

| | Kidney bean peel | |
|---|---|---|
| | (per 100 g) | |
| Amount of heat | 14 | kcal |
| Water | 93.2 | g |
| Protein | 0.3 | g |
| Lipid | smaller than 0.1 g | |
| Sugar | 0.1 | g |
| Vegetable fiber | 6.3 | g |
| Carbohydrate | 6.4 | g |
| Ash | 0.1 | g |
| Iron | 0.18 | mg |
| Sodium | 7.30 | mg |
| Potassium | 44.10 | mg |
| Calcium | 21.20 | mg |
| Magnesium | 11.20 | mg |
| Zinc | 0.07 | mg |

Then, the thus-obtained green tea powder-containing soft bean jelly (Example) was also subjected to the same “sensory evaluation” as in said Example using green tea powder-containing soft bean jelly prepared at the formulation ratio described in detail in said Preparation Example 2 from a kidney bean peel powder obtained by a conventional dry milling process (Comparative Example). As a result of the sensory test for confirming smooth texture, almost the same evaluation as above was obtained.

The specific constitutions of Examples of the present invention are not intended to be limited to each of said Examples. Various changes or modifications can be made, for example, for design, without departing from the sprit of the present invention described in claims 1 to 6, and such changes are encompassed by the present invention.

Examples of the bean peel used as a raw material for a food material can include soybean peels, black bean peels, and other bean peels.

1.-2. (canceled)

3. A method for producing a food material made of a bean peel as a raw material, comprising:
a primary milling step of milling a peel separated from a bean into a desired particle size, and
a secondary milling step of milling the peel powder obtained by said primary milling step into fine particles with a finer particle size by a wet milling process.

4. The method for producing a food material made of a bean peel as a raw material according to claim 3, further comprising a water addition adjustment step of adjusting the water content of the peel powder obtained by said primary milling step to a predetermined level.

5. The method for producing a food material made of a bean peel as a raw material according to claim 3, wherein said wet milling process is an ultra-high-pressure milling process performed under a pressure of 80 to 200 Mps.

6. The method for producing a food material made of a bean peel as a raw material according to claim 4, wherein said wet milling process is an ultra-high-pressure milling process performed under a pressure of 80 to 200 Mps.

7. The method for producing a food material made of a bean peel as a raw material according to claim 3, wherein said peel powder obtained by said wet milling process has palisade tissues separated in a fine, elongated form and has a particle size of 20 to 80 μm and particle size distribution of 50% or more in terms of a relative particle volume in cumulative Q3 distribution.
